(19) United States
(12) Patent Application Publication
(10) Pub. No.: US 2003/0146717 A1
(43) Pub. Date: Aug. 7, 2003

(54) Light string control device

(76) Inventor: Kun-Szu Chiang, Hui-Yang City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/067,184

(22) Filed: Feb. 4, 2002

(51) Int. Cl. H05B 37/02

(52) U.S. Cl. 315/291; 315/362

(57) ABSTRACT

A light string control device has a housing, a power input terminal and an output terminal formed in the housing, and a control circuit mounted inside the housing to connect between the power input terminal and the output terminal. The power input terminal is formed as a plug to connect to an AC power source. The output terminal is formed as a power outlet to connect to a light string. The control device can cause the light string to present as a constant lighting effect or a flashing effect based on the operation of the control circuit.

### BACKGROUND OF THE INVENTION

1. Field of Invention

The present invention relates to a light string control device, and more particularly to a light string control device that can easily cause the light string to present different vision effects.

2. Related Art

A light string has numerous small light bulbs connected in series and coated with flexible and transparent plastic material. When power is provided to the light string, each light bulb sends out soft light through the transparent plastic material and provides a decorative effect. The conventional light string is equipped with a plug to directly connect the light string to an electrical outlet. Thus the light string is constantly illuminated when power is supplied, and does not have any other luminance variations.

To overcome the shortcomings, the present invention provides a light string control device to mitigate and obviate the aforementioned problems.

### SUMMARY OF THE INVENTION

An objective of the light string control device in accordance with the present invention is to cause the light string to present different lighting effects.

To achieve the objective of the invention, the light string control device comprises a housing, a control circuit inside the housing, a plug connected to the housing via a wire and a power outlet in the housing to connect to a light string. When the light string is connected to the control device, the control device causes the light string to stay lit or to flash.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a light string control device in accordance with the present invention;

FIG. 2 is a circuit diagram of a control circuit in accordance with the present invention; and

FIG. 3 is a functional block diagram of the control circuit in FIG. 2.

### DETAILED DESCRIPTION OF THE INVENTION

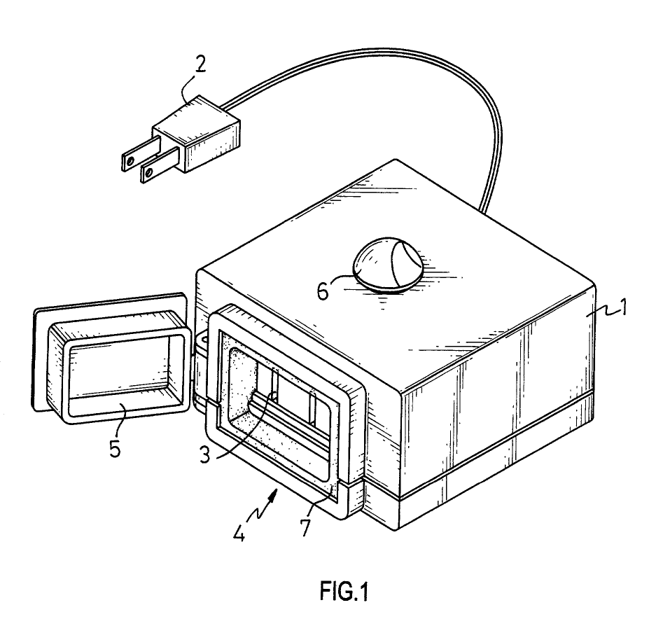

With reference to FIG. 1, a light string control device in accordance with the present invention comprises a housing (1), an AC power input terminal and an output terminal. The power input terminal is formed by a plug (2) connected to the housing (1) via a wire (not numbered). The output terminal is formed as a power outlet (3) to which a light string (not shown) is connected. The power outlet (3) is formed in a recess (4) defined in a surface of the housing (1). A cover (5) is pivotally connected to a side of the recess (4). When the light string is disconnected from the control device, the cover (5) can be shut to seal the recess (4) to prevent water from entering the recess (4). The control circuit (not shown in FIG. 1) is mounted inside the housing (1) to control the light string. A switch button (6) is mounted on a top surface of the housing (1) and is connected to a switch (16) in the control circuit. An elastic frame (7), which can be made by rubber, is formed around an internal wall surface of the recess (4). When a plug of the light string is connected to the power outlet (3), the elastic wall portion (7) can tightly bind the plug inside the recess (4) and prevent water from entering the recess (4).

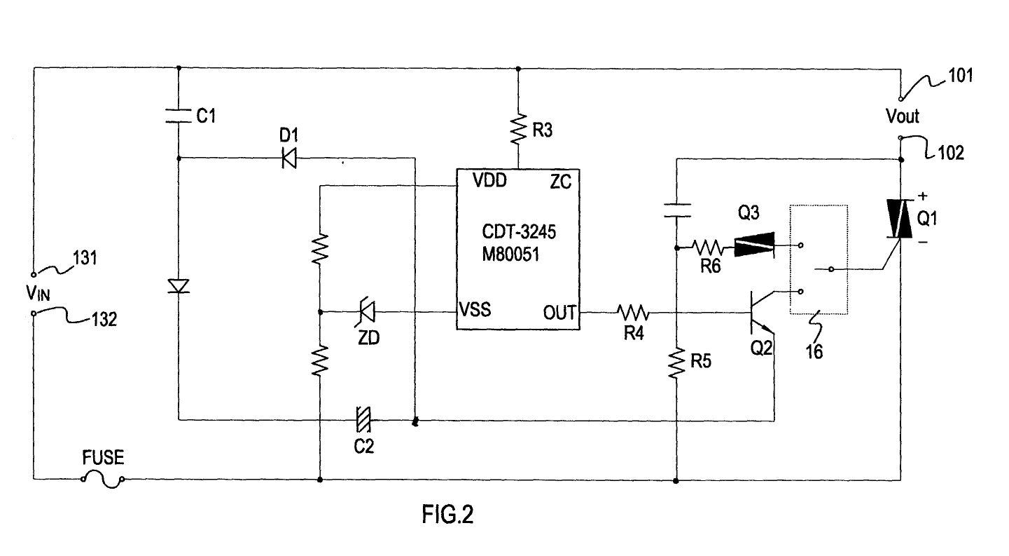

With reference to FIG. 2, the control circuit inside the housing (1) is comprised of a processor (11), a transistor (Q2), a triode AC switch (TRIAC) (Q1), a diode AC switch (DIAC) (Q3), a switch (16) and numerous discrete electrical components including resistors, capacitors, diodes, etc. The transistor (Q2) has a base (not numbered), a collector (not numbered) and an emitter (not numbered). The triode AC switch (TRIAC) (Q1) has a positive, negative and gate terminal (not numbered). An output terminal (OUT) of the processor (11) is connected to the base of the transistor (Q2). The collector of the transistor (Q2) is connected to the switch (16). A first terminal (131) of an AC power source (V_{IN}) is connected to a first terminal (101) of the power outlet (3). A second input terminal (132) of the AC power source (V_{IN}) is connected to a second terminal (102) of the power outlet (3) through the fuse and the negative terminal of the TRIAC (Q1). The gate terminal of the TRIAC (Q1) is connected to the switch (16). The positive terminal of the TRIAC (Q1) is connected to the second terminal (102) of the power outlet (3). The switch (16) further connects through the diode AC switch (DIAC) (Q3), a resistor (R6) and a capacitor (C3) to the second terminal (102) of the power outlet (3).

When the TRIAC (Q1) is switched to connect to the DIAC (Q3) via the switch (16), a loop is formed by the AC power source (V_{IN}), the power outlet (3), the TRIAC (Q1), the switch (16), the DIAC (Q3), resistors R6 and R5 and the fuse. Therefore, a current from the AC power source (V_{IN}) passes through and energizes the light string to maintain continuous lighting.

When the TRIAC (Q1) is connected to the transistor (Q2) by the switch (16) and the processor (11) outputs a pulse to turn on the transistor (Q2), the gate of the TRIAC (Q1) receives a triggering voltage from a capacitor (C2). Thus the TRIAC (Q1) is turned on, and another loop is formed by the TRIAC (Q1), the fuse, the AC power source (V_{IN}) and the power outlet (3), whereby the light string emits light. When the processor (11) has no pulse output to the transistor (Q2), the transistor (Q2) is turned off. There is no triggering voltage provided to the gate of the TRIAC (Q1), so the TRIAC (Q1) is off and the light string is turned off. Therefore, by repeatedly outputting pulse signals, the light string presents a flashing visual effect.

From the foregoing description, the user only has to press the switch button (6) to change the connection among the TRIAC (Q1), the DIAC (Q3) and the transistor (Q2), and the corresponding lighting effect can be performed.

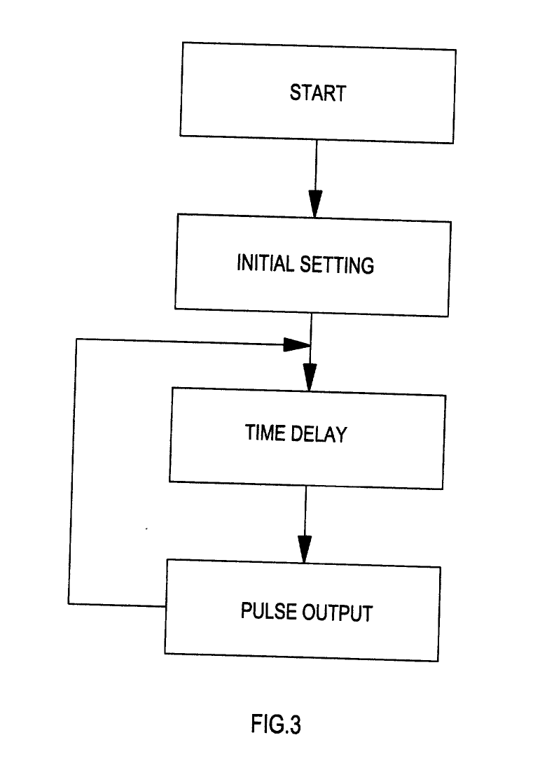

With reference to FIG. 3, a pulse generation program stored in the processor (11) comprises the starting the program, making initial delay settings, performing the appropriate time delay and outputting the pulse. In the making initial delay settings step, a duration time between two pulse signals and a pulse duration are set into the processor (11). After the processor (11) delays for the prescribed time, the pulse signal is then output for the prescribed time.

The invention may be varied in many ways by a skilled person in the art. Such variations are not to be regarded as a departure from the spirit and scope of the invention, and all such modifications are intended to be included within the scope of the following claims.

What is claimed is:

1. A light string control device comprising:
a housing having a power input terminal adapted to connect to a AC power source, and an output terminal adapted to connect to a light string;
a control circuit mounted inside the housing and connected between the power input terminal and the output terminal, wherein the control circuit generates pulse signals to control the light string.

2. The light string control device as claimed in claim 1, wherein the control circuit comprises a processor, a switch controlled by the processor and a pulse generation program stored in the processor, wherein the pulse generation program comprises the steps of setting initial delays, time delaying and outputting a pulse.

3. The light string control device as claimed in claim 1, wherein the power input terminal is formed as a plug that is connected to the housing via a wire, and the output terminal is a power outlet.

4. The light string control device as claimed in claim 3, wherein the power outlet is formed in a recess that is defined in a surface of the housing, and an elastic frame is formed around an inner wall surface of the recess, the power outlet is electrically connected to the control circuit.

5. The light string control device as claimed in claim 4, wherein a cover is pivotally connected to a side of the recess to selectively cover and seal the recess.
